(19) United States
(12) Patent Application Publication
(10) Pub. No.: US 2025/0266177 A1
(43) Pub. Date: Aug. 21, 2025

(54) WELD DOWN PIPE AND TUBE SUPPORT BASE

(71) Applicant: NuScale Power, LLC, Corvallis, OR (US)

(72) Inventors: Derek Noel, Albany, OR (US); Stephen Schaller, Denver, CO (US); Daniel Diefendorf, Albany, OR (US); John Van Why, Albany, OR (US)

(21) Appl. No.: 19/056,344

(22) Filed: Feb. 18, 2025

Related U.S. Application Data
(60) Provisional application No. 63/555,442, filed on Feb. 20, 2024.

(51) Int. Cl. G21C 13/024; F16L 3/10

(52) U.S. Cl. CPC G21C 13/024; F16L 3/1091

(57) ABSTRACT

A mount support system comprising a base having a first end and a second end opposite the first end. The base including a first surface configured to engage a clamp, a second surface configured to engage with an installation surface, a first T-slot extending at from the first end toward a center of the base, and a second T-slot extending from the second end toward the center of the base. The clamp including a lower portion configured to engage with the base, and an upper portion configured to engage with the lower portion, at least one fastener extending through the clamp configured to engage with at least one of the first T-slot and the second T-slot, and configured to penetrate the lower portion of the clamp and the upper portion of the clamp, and at least one fastening device configured to couple with the at least one fastener.

### CROSS-REFERENCE TO RELATED APPLICATION(S)

This application claims the benefit of U.S. Provisional Patent Application No. 63/555,442 filed Feb. 20, 2024 and titled “Weld Down Pipe and Tube Support Base,” which is incorporated herein by reference in its entirety.

### STATEMENT REGARDING FEDERALLY SPONSORED RESEARCH

This invention was made with Government support under Contract No. DE-NE-0008928 awarded by the Department of Energy. The Government has certain rights in this invention.

### BACKGROUND

Nuclear reactors utilize a network of pipes and tubes to transport various fluids at various temperatures and pressures. In some circumstances, pipes and/or tubes must be secured in place using pipe and/or tube supports. Attaching pipe and tube supports to a reactor pressure vessel (RPV) and/or a containment vessel (CNV) may require special considerations because of various regulatory requirements set forth by various governing bodies. Accordingly, various constraints under regulatory requirements are considered for pipe and tube support mounting systems and components.

### BRIEF DESCRIPTION OF THE DRAWINGS

FIG. 1 schematically illustrates an integrated power plant system that includes a power plant system that uses a small modular nuclear reactor (SMR) system with nuclear power modules (NPMs) that include a weld down pipe and tube support base system, according to an embodiment of this disclosure.

FIG. 2 illustrates an isometric view, depicting front, top, and side of an installed weld down pipe and tube support base system, according to an embodiment of this disclosure.

FIG. 3A illustrates an isometric view, depicting front, top, and side of a weld down pipe and tube support base system, according to an embodiment of this disclosure.

FIG. 3B illustrates a close-up view of a portion of the front and side of the weld down pipe and tube support base system of FIG. 3A, according to an embodiment of this disclosure.

FIG. 4 illustrates an isometric view, depicting front, bottom, and side of the weld down pipe and tube support base system of FIG. 3A, according to an embodiment of this disclosure.

FIG. 5 illustrates an isometric view, depicting front, top, and side of the weld down pipe and tube support base (“base”) of FIG. 3A, according to an embodiment of this disclosure.

FIG. 6 illustrates an isometric view, depicting bottom, top, and side of the weld down pipe and tube support base (“base”) of FIG. 3A, according to an embodiment of this disclosure.

FIG. 7 is a partially schematic, partially cross-sectional view of a nuclear reactor system configured in accordance with embodiments of the present technology.

FIG. 8 is a partial schematic, partial cross-sectional view of a nuclear reactor system configured in accordance with additional embodiments of the present technology.

FIG. 9 is a schematic view of a nuclear power plant system including multiple nuclear reactors in accordance with embodiments of the present technology.

### DETAILED DESCRIPTION

### Overview

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

This disclosure is directed to pipe supports for use in nuclear reactors (e.g., small modular nuclear reactors (SMRs), pressurized water reactors, advanced reactors, etc.). While specifically, discussed as being useful for nuclear reactors, the pipe supports may be useful in other applications for other systems.

Specific details of several embodiments of the present technology are described herein. The present technology, however, may be practiced without some of these specific details. In some instances, well-known structures and techniques often associated with steam generation, nuclear power conversion systems, and the like have not been shown in detail so as not to obscure the present technology.

The terminology used in the description presented below is intended to be interpreted in its broadest reasonable manner, even though it is used in conjunction with a detailed description of certain specific embodiments according to this disclosure. Certain terms may be emphasized below; however, any terminology intended to be interpreted in any restricted manner may be overtly and specifically defined as such in this Detailed Description section.

The headings provided herein are for convenience only and should not be construed as limiting the subject matter disclosed.

### Illustrative Embodiments

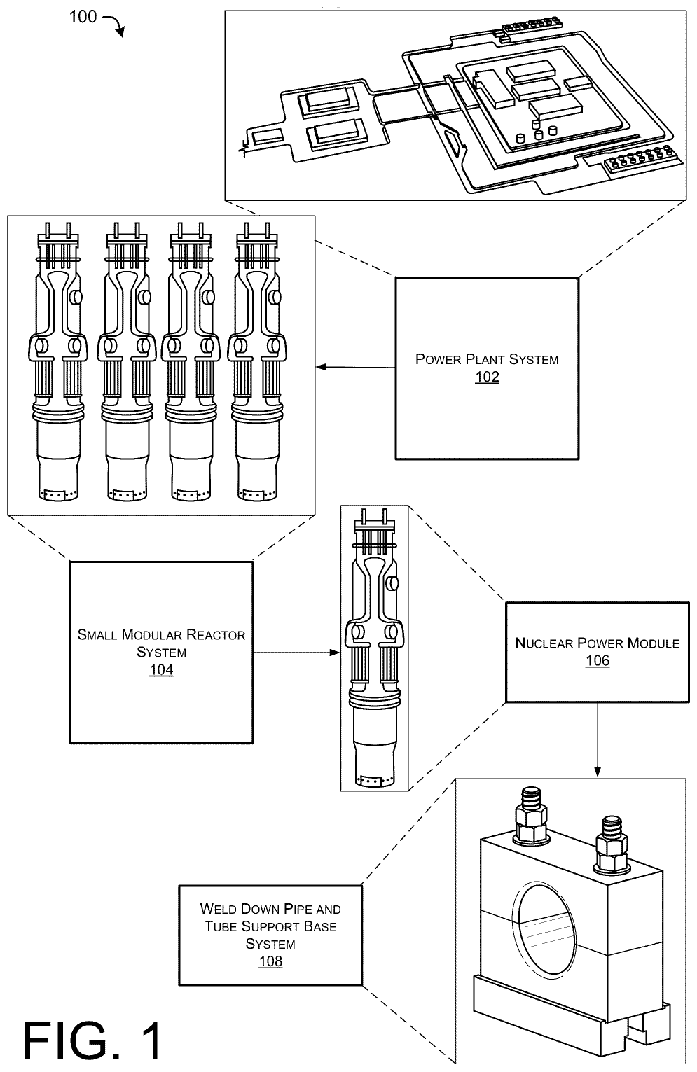

FIG. 1 schematically illustrates an integrated power plant system 100 that includes a power plant system 102 that uses a small modular nuclear reactor (SMR) system 104 with one or more nuclear power modules (NPMs) 106 that include a weld down pipe and tube support base system 108 (“support base system”), according to an embodiment of this disclosure.

In an embodiment, the SMR system 104 may include a multi-module power plant design with similar NPMs. In an embodiment, the SMR system 104 may represent any type of power plant system (e.g., advanced nuclear reactor system, microreactor system, pressurized heavy water nuclear reactor system, etc.). For example, the power plant system 102 may include multiple SMRs with the same or different sizes and/or operating characteristics.

In an embodiment, the support base system 108 may be installed on a surface of one or more NPMs 106. For example, the support base system 108 may be installed vertically, horizontally, or angularly, on an inside surface of the NPM 106. When installed, the support base system 108 may be used as an anchor point (i.e., mounting point, stabilization point, etc.) for various support system components (e.g., fluid piping, fluid tubing, electrical conduit, control rod drive system, containment system, and reactor pressure vessel and containment vessel flange test port tubing, etc.). In an embodiment, the support base system 108 may be used on the containment system flooding and drain piping inside of the containment vessel of the one or more NPMs 106.

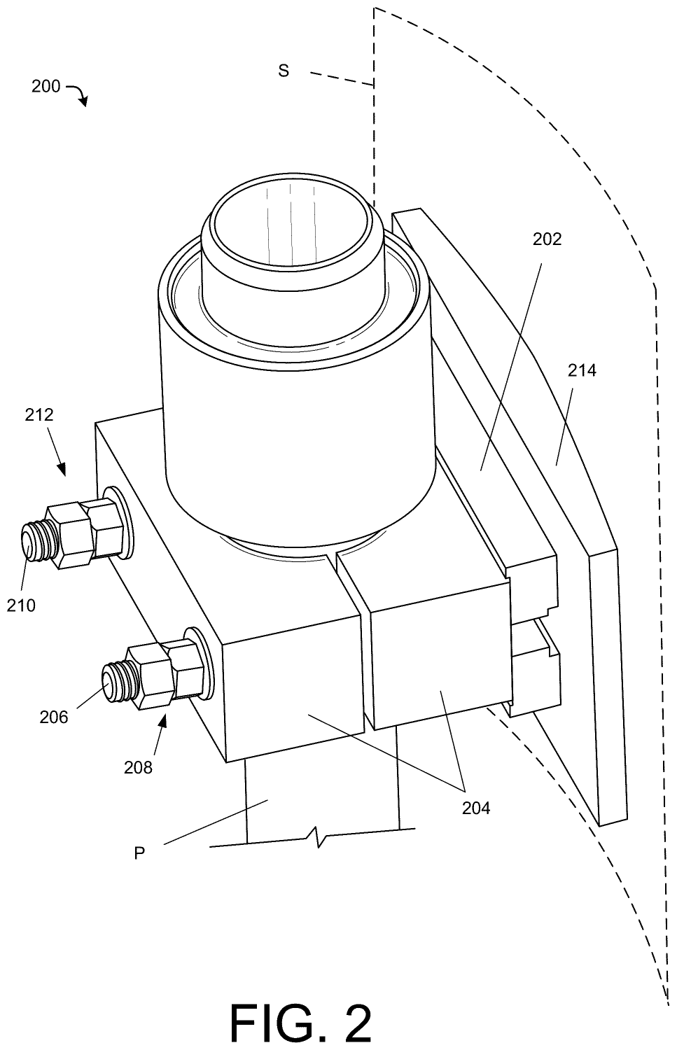

FIG. 2 illustrates an isometric front, top, and side view of an installed weld down pipe and tube support base system 200 (“support base system”), according to an embodiment of this disclosure. In an embodiment, the support base system 200 may include a weld down pipe and tube support base 202 (e.g., base plate, base, support base, etc.), clamp 204 (e.g., tube support, pipe support, conduit support, etc.), first bolt 206 (e.g., first fastener, etc.), first fastening device 208, second bolt 210 (e.g., second fastener, etc.), and second fastening device 212.

In an embodiment, the clamp 204 may be configured to secure component P to base 202. In an embodiment, the first fastening device 208 and the second fastening device 212 may include one or more nuts, one or more locknuts, one or more washers, one or more lock washers, or any other fastener configured to engage with the first bolt 206 and/or the second bolt 210. In an embodiment the base 202 may be attached (e.g., welded, etc.) to a mounting plate 214 that may be attached to mounting surface S (e.g., reactor pressure vessel wall, containment vessel wall, installation surface, etc.). In an embodiment, the base 202 may be attached (e.g., welded, etc.) directly to the mounting surface S (e.g., reactor pressure vessel wall, containment vessel wall, installation surface, etc.).

In an embodiment, the mounting surface S may be curved (e.g., convex, concave, etc.) and the mounting plate 214 may include a first surface configured to planarly engage the curved mounting surface S, and a second surface that is configured to planarly engage with the base 202.

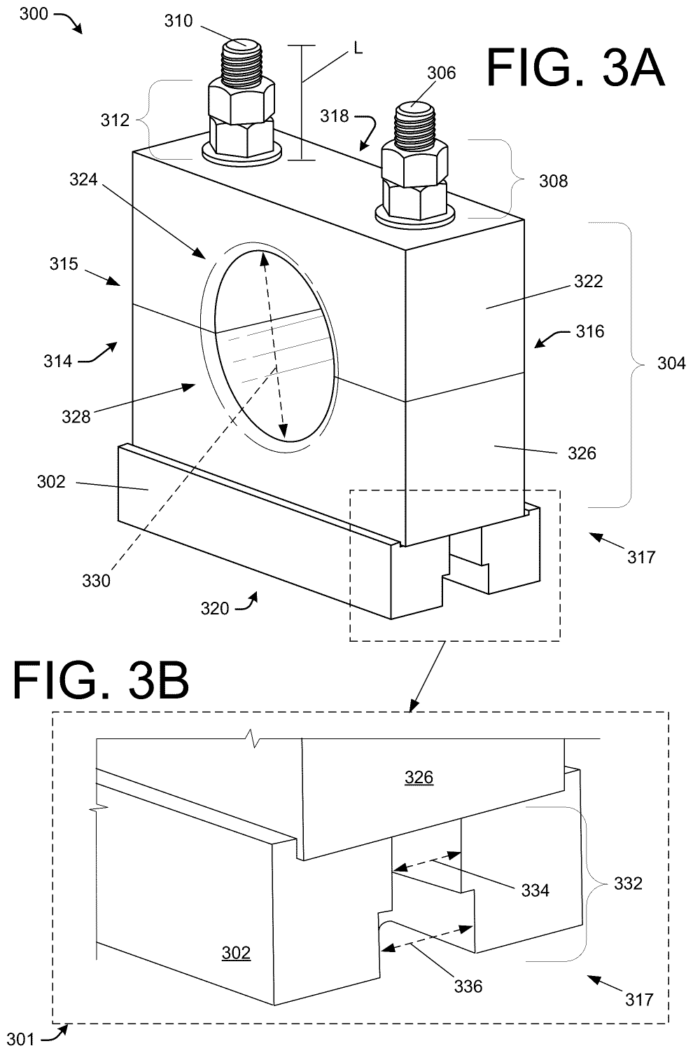

FIG. 3A illustrates an isometric front, top, and side view of a weld down pipe and tube support base system 300 (“support base system”), according to an embodiment of this disclosure. In an embodiment, the support base system 300 may include a weld down pipe and tube support base 302 (e.g., base plate, base, support base, etc.), clamp 304 (e.g., tube support, pipe support, conduit support, etc.), first bolt 306, first fastening device 308, second bolt 310, and second fastening device 312.

In an embodiment, the support base system 300 may have a front side 314 (e.g., front end, front face, etc.), a first side 315, a rear side 316 (e.g., rear end, rear face, etc.), a second side 317, a top end 318 (e.g., top side, top face, first end, etc.), and a bottom end 320 (e.g., bottom side, bottom face, second end, etc.).

In an embodiment, the clamp 304 may include an upper portion 322 (e.g., top portion, upper half, top half, etc.). In an embodiment, the upper portion 322 may include a channel 324 (e.g., first channel, top channel, cutout, curved portion, etc.) that extends from the front side 314 to the rear side 316. In an embodiment, the clamp 304 may include a lower portion 326 (e.g., bottom portion, lower half, bottom half, etc.). In an embodiment, the lower portion 326 may include a channel 328 (e.g., second channel, bottom channel, cutout, curved portion, etc.) that extends from the front side 314 to the rear side 316.

In an embodiment, the upper portion 322 and the lower portion 326 may be installed such that the first channel 324 and the second channel 328 may form aperture 330 extending from the front side 314 of the clamp 304 to the rear side 316 of the clamp 304. At the time of manufacture, the aperture 330 may be sized and shaped to accommodate any size and/or shape as required (e.g., 1 inch steam pipe, ¾ inch steam pipe, etc.).

In an embodiment, the first bolt 306 and the second bolt 310 may be sized to extend from the base 302, through (e.g., penetrate, etc.) the lower portion 326 of the clamp 304, through (e.g., penetrate, etc.) the upper portion 322 of the clamp 304, and extend past the top end 318 of the clamp 304 at a length L, as desired. In an embodiment, the first fastening device 308 and the second fastening device 312 may be configured to engage with the first bolt 306 and the second bolt 310, respectively, along length L.

In an embodiment, the first fastening device 308 and the second fastening device 312 may include lock nut(s), lock washer(s), jam nut(s), flat washer(s), or any other suitable fastener configured to engage with the first bolt 306 and the second bolt 310, respectively.

In an embodiment, the clamp 304 may be coupled to the base 302 via first bolt 306, first fastening device 308, second bolt 310, and second fastening device 312. In an embodiment, the base 302 may be configured to secure a bottom end 320 of the first bolt 306 and a bottom end 320 of the second bolt 310 in place such that neither the first bolt 306 nor the second bolt 310 may rotate. When the clamp 304 is installed on the base 302 the first bolt 306 and the second bolt 310, rotation of the first fastening device 308 and the second fastening device 312 may tighten the clamp 304 against the base 302.

FIG. 3B illustrates a close-up view 301 of a portion of the front and side of the weld down pipe and tube support base system 300 (“support base system”) of FIG. 3A, according to an embodiment of this disclosure.

In an embodiment, the base 302 may include a T-slot 332 (e.g., first T-slot, etc.) that extends from the second side 317 toward the first side 315 (not shown in FIG. 3B, see FIG. A). In an embodiment, the T-slot 332 may include a first width 334 that is sized to accommodate a shank (e.g., shaft, etc.) portion of a bolt (e.g., first bolt 306, second bolt 310, etc.). In an embodiment, the T-slot 332 may include a second width 336 that is sized to slidably accommodate (e.g., receive, allow, accept, etc.) the head of a bolt (e.g., first bolt 306, second bolt 310, etc.). For example, the head of first bolt 306 may slide into the portion (e.g., first portion, second portion, etc.) of the T-slot 332 that has second width 336. In an embodiment, the second width 336 may be such that the head of a bolt may fit within second width 336 but may not rotate freely within the second width 336.

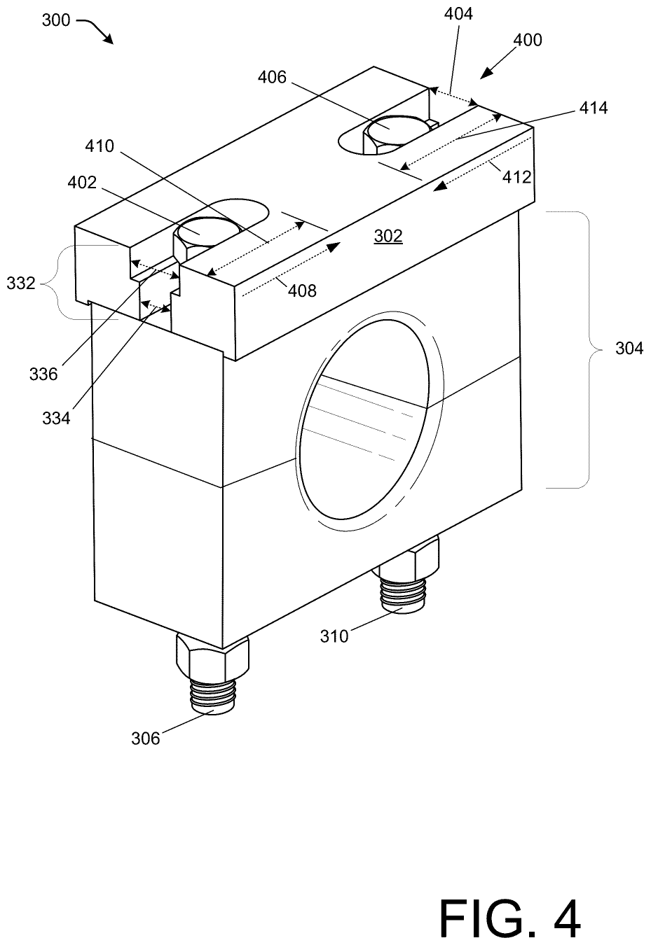

FIG. 4 illustrates an isometric front, bottom, and side view of the weld down pipe and tube support base system 300 of FIG. 3A, according to an embodiment of this disclosure. In an embodiment, the base 302 may include the T-slot 332 and a T-slot 400 (e.g., second T-slot, etc.). In an embodiment, the first bolt 306 may include a bolt head 402. The bolt head 402 may be sized to fit within the T-slot 332 at the second width 336 such that the first bolt 306 may not rotate.

In an embodiment, the T-slot 400 may include a first width (not shown) that is sized to accommodate a shank (e.g., shaft, etc.) portion of the second bolt 310. The T-slot 400 may include a second width 404 sized to accommodate a bolt head 406 of the second bolt 310. In an embodiment, the second bolt 310 may include a bolt head 406. The bolt head 406 may be sized to fit within the T-slot 400 at second width 404 such that the second bolt 310 may not rotate.

In an embodiment, the T-slot 332 may extend in a first direction 408 toward the T-slot 400. In an embodiment, the T-slot 332 may extend to length 410. In an embodiment, the T-slot 400 may extend in a second direction 412 toward the T-slot 332. In an embodiment, the T-slot 400 may extend to length 414.

The orientation of T-slot 332 and T-slot 400 (i.e., on opposite ends of the base 302) allows for the first bolt 306 and the second bolt 310 to be installed after the base plate is welded in place. T-slot 332 and T-slot 400 prevent the first bolt 306 and the second bolt 310 from rotating, when installed in the base 302. Length 410 and length 414 of T-slot 332 and T-slot 400, respectfully, are such that when the first bolt 306 and the second bolt 310 are installed, neither bolt may slide out of the open end of the T-slot before the opposite bolt hits the closed end of the slot.

In an embodiment, a strain relief feature may be cut into the center of the welded base to relieve the strain of being welded to a dissimilar material or expanding pressure vessel. For example, the portion of base 302 between the T-slot 332 and T-slot 400 (e.g., middle portion, middle section, center, etc.) may include a gap, groove, channel, or other modification to allow for expansion and/or contraction.

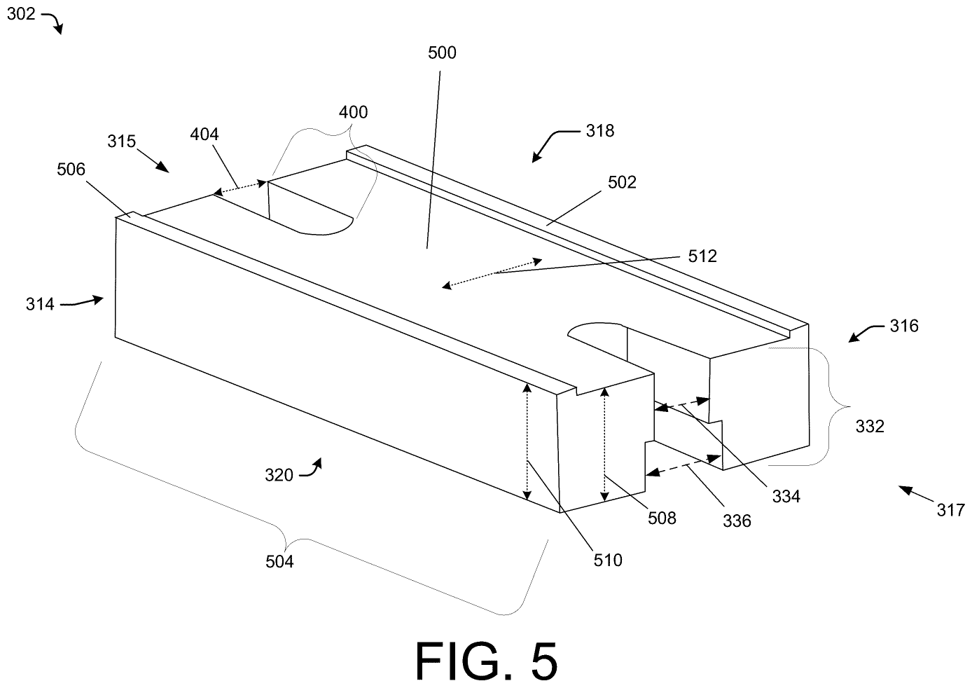

FIG. 5 illustrates an isometric front, top, and side view of the weld down pipe and tube support base 302 (“base”) of FIG. 3A, according to an embodiment of this disclosure.

In an embodiment, the base 302 may include a clamp surface 500 (e.g., first surface, second surface, etc.) at the top end 318 of the base 302. In an embodiment, the rear side 316 of the base 302 may include a lip 502 (e.g., raised edge, shoulder, etc.) that extends (e.g., runs, follows, etc.) along the length 504 of the base 302. In an embodiment, the front side 314 of the base 302 may include a lip 506 (e.g., raised edge, shoulder, etc.) that extends (e.g., runs, follows, etc.) along the length 504 of the base 302.

In an embodiment, when the lower portion 326 (not shown in FIG. 5, see FIG. 3A and/or FIG. 3B), is planarly engaged with the clamp surface 500, the lip 502 and the lip 506 prevent the lower portion 326 from moving in a direction 512. For example, in an embodiment, when the lower portion 326 is engaged with the clamp surface 500, the lip 506 may be engaged with the front side 314 of the lower portion 326, and the lip 502 may be engaged with the rear side 316 of the lower portion 326.

In an embodiment, the lip 502 and the lip 506 may extend past the clamp surface 500 in a direction away from the clamp surface 500. For example, in an embodiment, the distance between the bottom end 320 of the base 302 to the clamp surface 500 may extend to a height 508, and the bottom end 320 of the base 302 may extend to the top end 318 of the lip 502/506 at height 510, wherein height 510 is greater than height 508. At the time of manufacture of the base 302, the lip 502 and the lip 506 may be configured such that the height 510 may be greater than the height 508 as desired.

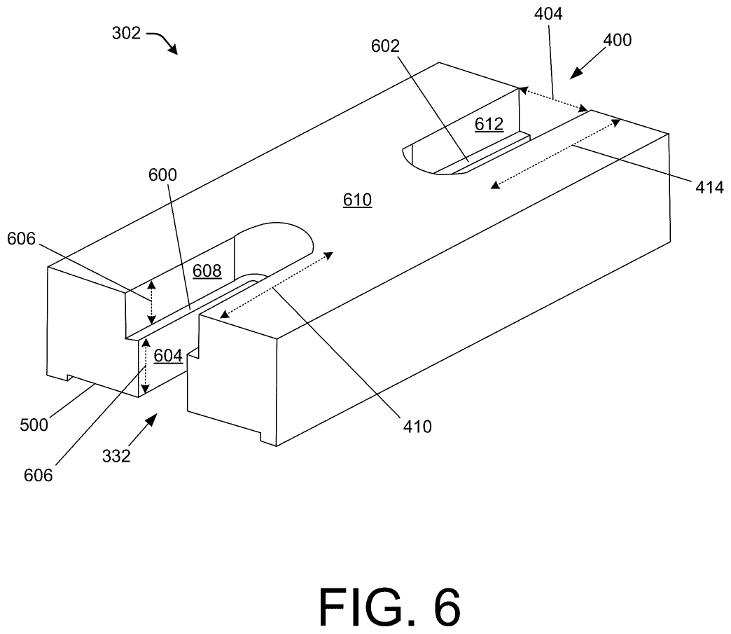

FIG. 6 illustrates an isometric bottom, top, and side view of the weld down pipe and tube support base 302 (“base”), according to an embodiment of this disclosure. In an embodiment, the base 302 may include a mounting surface 610 (e.g., first surface, second surface, etc.). The mounting surface 610 may be configured to engage with the mounting plate 214 (not shown in FIG. 6, see FIG. 2). In an embodiment, the mounting surface 610 may be engaged with the mounting plate 214 when the base 302 is welded to the mounting plate 214.

In an embodiment, the T-slot 332 may include a ledge 600. In an embodiment, the T-slot 400 may include a ledge 602. The ledge 600 and the ledge 602 may extend along the length 410 and the length 414, respectively.

In an embodiment, the T-slot 332 may include an inner wall 604 that extends from the clamp surface 500 to the ledge 600 at a height 606. In an embodiment, the T-slot 332 may include an inner wall 608 that extends from the ledge 600 to a mounting surface 610.

In an embodiment, the inner wall 608 may be configured to engage with the outside surface of a bolt head (e.g., bolt head 402, bolt head 406, etc.) such that the bolt head may not rotate.

In an embodiment, the T-slot 400 may be mirror identical to the T-slot 332. For example, the inner wall 612 of the T-slot 400 may be identical in form and function of the inner wall 608 of the T-slot 332 and the ledge 602 of T-slot 400 may be identical in form and function of the ledge 600 of the T-slot 332.

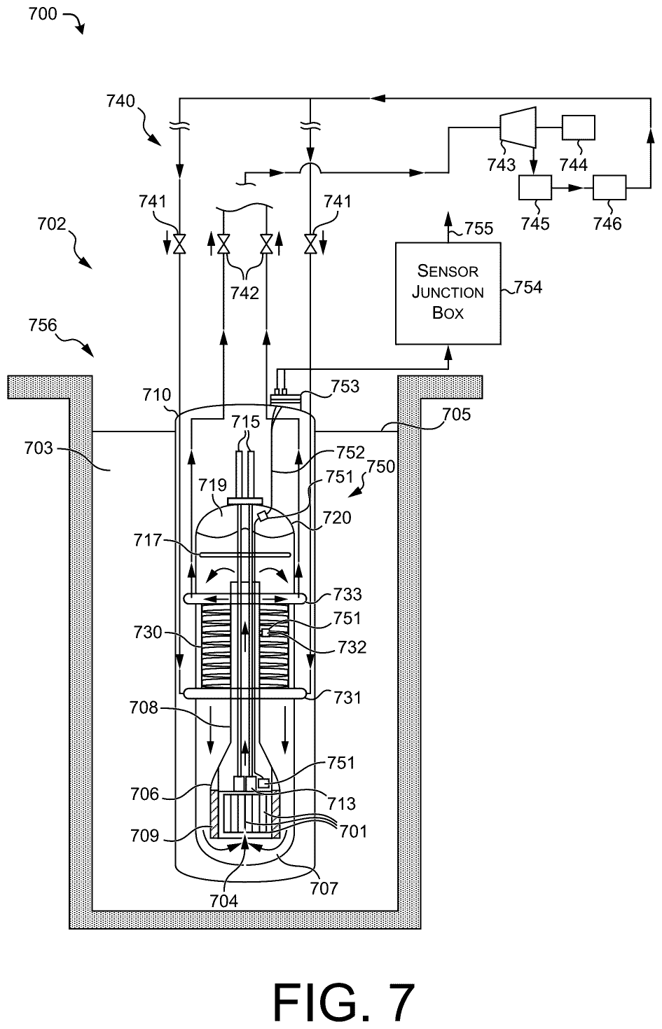

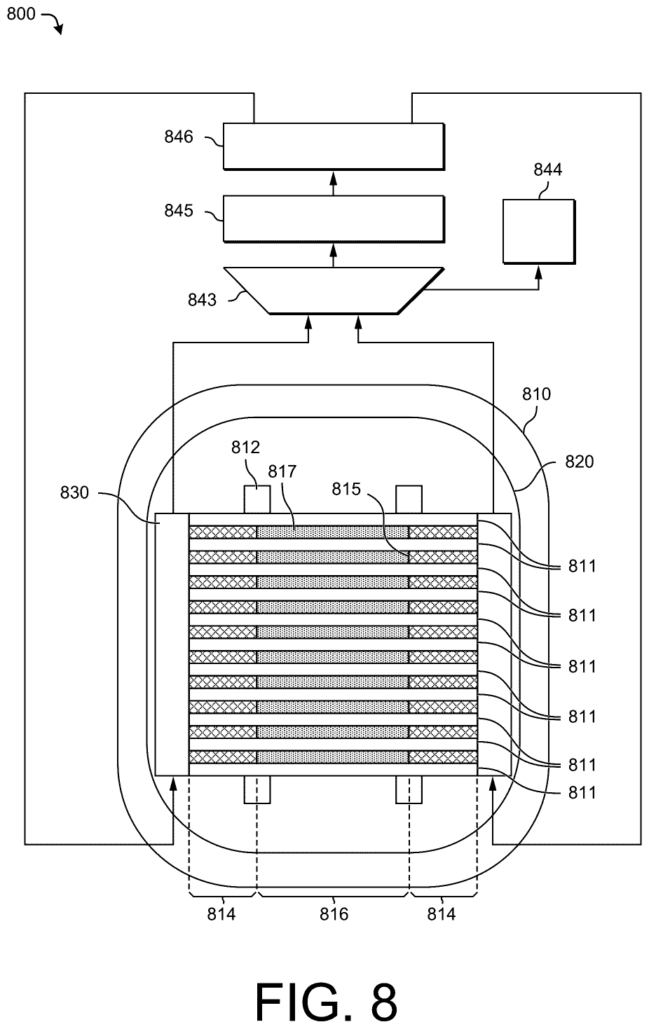

FIGS. 7 and 8 illustrate representative nuclear reactors that may be included in embodiments of the present technology. FIG. 7 is a partially schematic, partially cross-sectional view of a nuclear reactor system 700 configured in accordance with embodiments of the present technology. The system 700 can include a power module 702 having a reactor core 704 in which a controlled nuclear reaction takes place. Accordingly, the reactor core 704 can include one or more fuel assemblies 701. The fuel assemblies 701 can include fissile and/or other suitable materials. Heat from the reaction generates steam at a steam generator 730, which directs the steam to a power conversion system 740. The power conversion system 740 generates electrical power, and/or provides other useful outputs, such as super-heated steam. A sensor system 750 is used to monitor the operation of the power module 702 and/or other system components. The data obtained from the sensor system 750 can be used in real time to control the power module 702, and/or can be used to update the design of the power module 702 and/or other system components.

The power module 702 includes a containment vessel 710 (e.g., a radiation shield vessel, or a radiation shield container) that houses/encloses a reactor vessel 720 (e.g., a reactor pressure vessel, or a reactor pressure container), which in tum houses the reactor core 704. The containment vessel 710 can be housed in a power module bay 756. The power module bay 756 can contain a cooling pool 703 filled with water and/or another suitable cooling liquid. The bulk of the power module 702 can be positioned below a surface 705 of the cooling pool 703. Accordingly, the cooling pool 703 can operate as a thermal sink, for example, in the event of a system malfunction.

A volume between the reactor vessel 720 and the containment vessel 710 can be partially or completely evacuated to reduce heat transfer from the reactor vessel 720 to the surrounding environment (e.g., to the cooling pool 703). However, in other embodiments the volume between the reactor vessel 720 and the containment vessel 710 can be at least partially filled with a gas and/or a liquid that increases heat transfer between the reactor vessel 720 and the containment vessel 710. For example, the volume between the reactor vessel 720 and the containment vessel 710 can be at least partially filled (e.g., flooded with the primary coolant 707) during an emergency operation.

Within the reactor vessel 720, a primary coolant 707 conveys heat from the reactor core 704 to the steam generator 730. For example, as illustrated by arrows located within the reactor vessel 720, the primary coolant 707 is heated at the reactor core 704 toward the bottom of the reactor vessel 720. The heated primary coolant 707 (e.g., water with or without additives) rises from the reactor core 704 through a core shroud 706 and to a riser tube 708. The hot, buoyant primary coolant 707 continues to rise through the riser tube 708, then exits the riser tube 708 and passes downwardly through the steam generator 730. The steam generator 730 includes a multitude of conduits 732 that are arranged circumferentially around the riser tube 708, for example, in a helical pattern, as is shown schematically in FIG. 7. The descending primary coolant 707 transfers heat to a secondary coolant (e.g., water) within the conduits 732, and descends to the bottom of the reactor vessel 720 where the cycle begins again. The cycle can be driven by the changes in the buoyancy of the primary coolant 707, thus reducing or eliminating the need for pumps to move the primary coolant 707.

The steam generator 730 can include a feedwater header 731 at which the incoming secondary coolant enters the steam generator conduits 732. The secondary coolant rises through the conduits 732, converts to vapor (e.g., steam), and is collected at a steam header 733. The steam exits the steam header 733 and is directed to the power conversion system 740.

The power conversion system 740 can include one or more steam valves 742 that regulate the passage of high pressure, high temperature steam from the steam generator 730 to a steam turbine 743. The steam turbine 743 converts the thermal energy of the steam to electricity via a generator 744. The low-pressure steam exiting the turbine 743 is condensed at a condenser 745, and then directed (e.g., via a pump 746) to one or more feedwater valves 741. The feedwater valves 741 control the rate at which the feedwater re-enters the steam generator 730 via the feedwater header 731. In other embodiments, the steam from the steam generator 730 can be routed for direct use in an industrial process, such as a Hydrogen (H₂) and Oxygen (O₂) production plant, a chemical production plant, and/or the like, as described in detail below. Accordingly, steam exiting the steam generator 730 can bypass the power conversion system 740.

The power module 702 includes multiple control systems and associated sensors. For example, the power module 702 can include a hollow cylindrical reflector 709 that directs neutrons back into the reactor core 704 to further the nuclear reaction taking place therein. Control rods 713 are used to modulate the nuclear reaction and are driven via fuel rod drivers 715. The pressure within the reactor vessel 720 can be controlled via a pressurizer plate 717 (which can also serve to direct the primary coolant 707 downwardly through the steam generator 730) by controlling the pressure in a pressurizing volume 719 positioned above the pressurizer plate 717.

The sensor system 750 can include one or more sensors 751 positioned at a variety of locations within the power module 702 and/or elsewhere, for example, to identify operating parameter values and/or changes in parameter values. The data collected by the sensor system 750 can then be used to control the operation of the system 700, and/or to generate design changes for the system 700. For sensors positioned within the containment vessel 710, a sensor link 752 directs data from the sensors to a flange 753 (at which the sensor link 752 exits the containment vessel 710) and directs data to a sensor junction box 754. From there, the sensor data can be routed to one or more controllers and/or other data systems via a data bus 755.

FIG. 8 is a partially schematic, partially cross-sectional view of a nuclear reactor system 800 configured in accordance with additional embodiments of the present technology. In some embodiments, the nuclear reactor system 800 (“system 800”) can include some features that are at least generally similar in structure and function, or identical in structure and function, to the corresponding features of the system 700 described in detail above with reference to FIG. 7, and can operate in a generally similar or identical manner to the system 700.

In the illustrated embodiment, the system 800 includes a reactor vessel 820 and a containment vessel 810 surrounding/enclosing the reactor vessel 820. In some embodiments, the reactor vessel 820 and the containment vessel 810 can be roughly cylinder-shaped or capsule-shaped. The system 800 further includes a plurality of heat pipe layers 811 within the reactor vessel 820. In the illustrated embodiment, the heat pipe layers 811 are spaced apart from and stacked over one another. In some embodiments, the heat pipe layers 811 can be mounted/secured to a common frame 812, a portion of the reactor vessel 820 (e.g., a wall thereof), and/or other suitable structures within the reactor vessel 820. In other embodiments, the heat pipe layers 811 can be directly stacked on top of one another such that each of the heat pipe layers 811 supports and/or is supported by one or more of the other ones of the heat pipe layers 811.

In the illustrated embodiment, the system 800 further includes a shield or reflector region 814 at least partially surrounding a core region 816. The heat pipe layers 811 can be circular, rectilinear, polygonal, and/or can have other shapes, such that the core region 816 has a corresponding three-dimensional shape (e.g., cylindrical, spherical). In some embodiments, the core region 816 is separated from the reflector region 814 by a core barrier 815, such as a metal wall. The core region 816 can include one or more fuel sources, such as fissile material, for heating the heat pipe layers 811. The reflector region 814 can include one or more materials configured to contain/reflect products generated by burning the fuel in the core region 816 during operation of the system 800. For example, the reflector region 814 can include a liquid or solid material configured to reflect neutrons and/or other fission products radially inward toward the core region 816. In some embodiments, the reflector region 814 can entirely surround the core region 816. In other embodiments, the reflector region 814 may partially surround the core region 816. In some embodiments, the core region 816 can include a control material 817, such as a moderator and/or coolant. The control material 817 can at least partially surround the heat pipe layers 811 in the core region 816 and can transfer heat therebetween.

In the illustrated embodiment, the system 800 further includes at least one heat exchanger 830 (e.g., a steam generator) positioned around the heat pipe layers 811. The heat pipe layers 811 can extend from the core region 816 and at least partially into the reflector region 814 and are thermally coupled to the heat exchanger 830. In some embodiments, the heat exchanger 830 can be positioned outside of or partially within the reflector region 814. The heat pipe layers 811 provide a heat transfer path from the core region 816 to the heat exchanger 830. For example, the heat pipe layers 811 can each include an array of heat pipes that provide a heat transfer path from the core region 816 to the heat exchanger 830. When the system 800 operates, the fuel in the core region 816 can heat and vaporize a fluid within the heat pipes in the heat pipe layers 811, and the fluid can carry the heat to the heat exchanger 830. The heat pipes in the heat pipe layers 811 can then return the fluid toward the core region 816 via wicking, gravity, and/or other means to be heated and vaporized once again.

In some embodiments, the heat exchanger 830 can be similar to the steam generator 730 of FIG. 7 and, for example, can include one or more helically-coiled tubes that wrap around the heat pipe layers 811. The tubes of the heat exchanger 830 can include or carry a working fluid (e.g., a coolant such as water or another fluid) that carries the heat from the heat pipe layers 811 out of the reactor vessel 820 and the containment vessel 810 for use in generating electricity, steam, and/or the like. For example, in the illustrated embodiment the heat exchanger 830 is operably coupled to a turbine 843, a generator 844, a condenser 845, and a pump 846. As the working fluid within the heat exchanger 830 increases in temperature, the working fluid may begin to boil and vaporize. The vaporized working fluid (e.g., steam) may be used to drive the turbine 843 to convert the thermal potential energy of the working fluid into electrical energy via the generator 844. The condenser 845 can condense the working fluid after it passes through the turbine 843, and the pump 846 can direct the working fluid back to the heat exchanger 830 where it can begin another thermal cycle. In other embodiments, steam from the heat exchanger 830 can be routed for direct use in an industrial process, such as an enhanced oil recovery operation described in detail below. Accordingly, steam exiting the heat exchanger 830 can bypass the turbine 843, the generator 844, the condenser 845, the pump 846, etc.

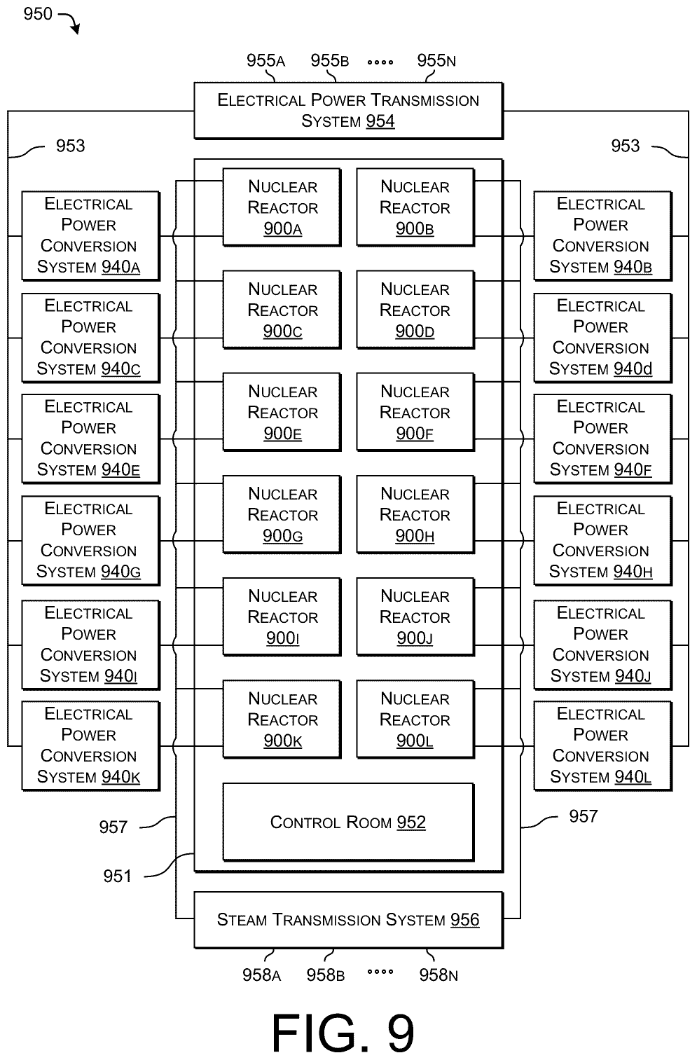

FIG. 9 is a schematic view of a nuclear power plant system 950 including multiple nuclear reactors 900 in accordance with embodiments of the present technology. Each of the nuclear reactors 900 (individually identified as first through twelfth nuclear reactors 900a-l, respectively) can be similar to or identical to the nuclear reactor 900 and/or the nuclear reactor 900 described in detail above with reference to FIGS. 7 and 8. The power plant system 950 (“power plant system 950”) can be “modular” in that each of the nuclear reactors 900 can be operated separately to provide an output, such as electricity or steam. The power plant system 950 can include fewer than twelve of the nuclear reactors 900 (e.g., two, three, four, five, six, seven, eight, nine, ten, or eleven of the nuclear reactors 900), or more than twelve of the nuclear reactors 900. The power plant system 950 can be a permanent installation or can be mobile (e.g., mounted on a truck, tractor, mobile platform, and/or the like). In the illustrated embodiment, each of the nuclear reactors 900 can be positioned within a common housing 951, such as a reactor plant building, and controlled and/or monitored via a control room 952.

Each of the nuclear reactors 900 can be coupled to a corresponding electrical power conversion system 940 (individually identified as first through twelfth electrical power conversion systems 940a-l, respectively). The electrical power conversion systems 940 can include one or more devices that generate electrical power or some other form of usable power from steam generated by the nuclear reactors 900. In some embodiments, multiple ones of the nuclear reactors 900 can be coupled to the same one of the electrical power conversion systems 940 and/or one or more of the nuclear reactors 900 can be coupled to multiple ones of the electrical power conversion systems 940 such that there is not a one-to-one correspondence between the nuclear reactors 900 and the electrical power conversion systems 940.

The electrical power conversion systems 940 can be further coupled to an electrical power transmission system 954 via, for example, an electrical power bus 953. The electrical power transmission system 954 and/or the electrical power bus 953 can include one or more transmission lines, transformers, and/or the like for regulating the current, voltage, and/or other characteristic(s) of the electricity generated by the electrical power conversion systems 940. The electrical power transmission system 454 can route electricity via a plurality of electrical output paths 955 (individually identified as electrical output paths 955a-n) to one or more end users and/or end uses, such as different electrical loads of an integrated energy system.

Each of the nuclear reactors 900 can further be coupled to a steam transmission system 956 via, for example, a steam bus 957. The steam bus 957 can route steam generated from the nuclear reactors 900 to the steam transmission system 956 which in tum can route the steam via a plurality of steam output paths 958 (individually identified as steam output paths 958a-n) to one or more end users and/or end uses, such as different steam inputs of an integrated energy system.

In some embodiments, the nuclear reactors 900 can be individually controlled (e.g., via the control room 952) to provide steam to the steam transmission system 956 and/or steam to the corresponding one of the electrical power conversion systems 940 to provide electricity to the electrical power transmission system 954. In some embodiments, the nuclear reactors 900 are configured to provide steam either to the steam bus 957 or to the corresponding one of the electrical power conversion systems 940 and can be rapidly and efficiently switched between providing steam to either. Accordingly, in some aspects of the present technology the nuclear reactors 900 can be modularly and flexibly controlled such that the power plant system 950 can provide differing levels/amounts of electricity via the electrical power transmission system 954 and/or steam via the steam transmission system 956. For example, where the power plant system 950 is used to provide electricity and steam to one or more industrial process-such as various components of the integrated energy systems, the nuclear reactors 900 can be controlled to meet the differing electricity and steam requirements of the industrial processes.

As one example, during a first operational state of an integrated energy system employing the power plant system 950, a first subset of the nuclear reactors 900 (e.g., the first through sixth nuclear reactors 900a-f) can be configured to provide steam to the steam transmission system 956 for use in the first operational state of the integrated energy system, while a second subset of the nuclear reactors 900 (e.g., the seventh through twelfth nuclear reactors 900g-l) can be configured to provide steam to the corresponding ones of the electrical power conversion systems 940 (e.g., the seventh through twelfth electrical power conversion systems 940g-l) to generate electricity for the first operational state of the integrated energy system. Then, during a second operational state of the integrated energy system when a different (e.g., greater or lesser) amount of steam and/or electricity is required, some or all the first subset of the nuclear reactors 900 can be switched to provide steam to the corresponding ones of the electrical power conversion systems 940 (e.g., the seventh through twelfth electrical power conversion systems 940g-l) and/or some or all of the second subset of the nuclear reactors 900 can be switched to provide steam to the steam transmission system 956 to vary the amount of steam and electricity produced to match the requirements/demands of the second operational state. Other variations of steam and electricity generation are possible based on the needs of the integrated energy system. That is, the nuclear reactors 900 can be dynamically/flexibly controlled during other operational states of an integrated energy system to meet the steam and electricity requirements of the operational state.

In contrast, some conventional nuclear power plant systems can typically generate either steam or electricity for output and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 900 can be individually controlled via one or more operators and/or via a computer system. Accordingly, many embodiments of the technology described herein may take the form of computer-or machine-or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured, or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

The above detailed description of embodiments of the present technology are not intended to be exhaustive or to limit the technology to the precise forms disclosed above. Although specific embodiments of, and examples for, the technology are described above for illustrative purposes, various equivalent modifications are possible within the scope of the technology, as those skilled in the relevant art will recognize. For example, although steps may be presented in a given order, in an embodiment, the steps may be performed in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A mount support system comprising:
a base having a first end and a second end opposite the first end, the base including:
a first surface extending from the first end to the second end, the first surface configured to engage a clamp,
a second surface opposite the first surface, the second surface configured to engage with an installation surface,
a first T-slot extending at least partially from the first end toward a center of the base, and
a second T-slot extending at least partially from the second end toward the center of the base,
the clamp including:
a lower portion configured to engage with the first surface of the base, and
an upper portion configured to engage with the lower portion,
at least one fastener extending through the clamp, the at least one fastener including:
a head configured to engage with at least one of the first T-slot or the second T-slot, and
a shaft configured to penetrate the lower portion of the clamp and the upper portion of the clamp, and
at least one fastening device configured to couple with the shaft of the at least one fastener.

2. The mount support system of claim 1, wherein the at least one fastener includes:
a first fastener, and
a second fastener, and
wherein the at least one fastening device includes:
a first fastening device, and
a second fastening device.

3. The mount support system of claim 1, wherein the first surface of the base includes:
a first lip running along a first edge of the first surface of the base, the first lip extending in a direction away from the first surface, and
a second lip running along a second edge of the first surface of the base opposite the first edge, the second lip extending in the direction.

4. The mount support system of claim 1, wherein:
the lower portion of the clamp includes:
a first surface configured to engage with the first surface of the base, and
a second surface opposite the first surface of the lower portion of the clamp, the second surface of the lower portion of the clamp including a curved portion that curves toward the first surface of the lower portion of the clamp.

5. The mount support system of claim 1, wherein:
the upper portion of the clamp includes:
a first surface configured to engage with the at least one fastening device, and
a second surface opposite the first surface of the upper portion of the clamp, the second surface of the upper portion of the clamp including a curved portion that curves toward the first surface of the upper portion of the clamp.

6. The mount support system of claim 1, wherein:
the base includes a middle portion between the first T-slot and the second T-slot, the middle portion including at least one of a gap, a groove, and a channel, wherein the middle portion is configured to expand or contract.

7. A support mount apparatus comprising:
a first side including:
a surface configured to engage with a clamp,
a first lip at a first edge, and
a second lip at a second edge,
a second side opposite the first side, the second side including a surface configured to engage with an installation surface,
a first T-slot extending at least partially from a first end of the support mount apparatus toward a center of the support mount apparatus, and
a second T-slot extending at least partially from a second end of the support mount apparatus toward the center of the support mount apparatus.

8. The support mount apparatus of claim 7, wherein:
the first T-slot includes:
a first portion having a first width, the first portion configured to receive a shaft of a fastener, and
a second portion having a second width that is greater than the first width, the second portion configured to receive a head the fastener, and
the second T-slot includes:
a first portion having a first width, the first portion configured to receive a shaft the fastener, and
a second portion having a second width that is greater than the first width, the second portion configured to receive the head of the fastener.

9. The support mount apparatus of claim 8, wherein:
the first T-slot further includes a ledge defined by the first portion and the second portion, the ledge configured to prevent the head of the fastener from entering the first portion from the second portion, and
the second T-slot further includes a ledge defined by the first portion and the second portion, the ledge configured to prevent the head of the fastener from entering the first portion from the second portion.

10. The support mount apparatus of claim 7, wherein:
the surface of the first side is configured to planarly engage with a bottom side of the clamp,
the first lip is configured to planarly engage with a first side of the clamp adjacent to the bottom side of the clamp, and
the second lip is configured to planarly engage with a second side of the clamp opposite the first side of the clamp.

11. The support mount apparatus of claim 7, wherein:
the first lip extends in a first direction away from the surface of the first side at a first height, and
the second lip extends in a second direction away from the surface of the first side at a second height.

12. The support mount apparatus of claim 7, wherein:
the first T-slot extends toward the center of the support mount apparatus in a first direction for a first length, and
the second T-slot extends toward the center of the support mount apparatus in a second direction that is opposite the first direction for a second length.

13. The support mount apparatus of claim 7, further comprising a middle portion between the first T-slot and the second T-slot, the middle portion including at least one of a gap, a groove, and a channel, wherein the middle portion is configured to expand or contract.

14. A clamping assembly, comprising:
a nuclear reactor vessel, and
a clamp assembly including:
a base configured to be welded to the nuclear reactor vessel,
a lower clamp portion configured to couple to the base,
an upper clamp portion configured to couple to the lower clamp portion,
at least one fastener extending through the base, the lower clamp portion, and the upper clamp portion, and
at least one fastening device configured to engage with the at least one fastener.

15. The clamping assembly of claim 14, wherein:
the base includes:
a first side including:
a surface configured to engage with the lower clamp portion,
a first lip at a first edge, and
a second lip at a second edge,
a second side opposite the first side, the second side including a surface configured to engage with the nuclear reactor vessel,
a first T-slot extending at least partially from a first end of base toward a center of the base, and
a second T-slot extending at least partially from a second end of the center toward the center of the center.

16. The clamping assembly of claim 15, wherein:
the at least one fastener includes:
a head configured to slidably engage with at least one of the first T-slot or the second T-slot, and
a shaft configured to penetrate the lower clamp portion and the upper clamp portion.

17. The clamping assembly of claim 15, wherein:
the first T-slot includes:
a first portion having a first width, the first portion configured to receive a shaft of the at least one fastener, and
a second portion having a second width that is greater than the first width, the second portion configured to receive a head of the at least one fastener, and
the second T-slot includes:
a first portion having a first width, the first portion configured to receive a shaft of the at least one fastener, and
a second portion having a second width that is greater than the first width, the second portion configured to receive a head of the at least one fastener.

18. The clamping assembly of claim 15, wherein:
the first T-slot extends toward the center of the base in a first direction for a first length, and
the second T-slot extends toward the center of the base in a second direction that is opposite the first direction for a second length.

19. The clamping assembly of claim 14, wherein:
the lower clamp portion includes:
a first surface configured to engage with the base, and
a second surface opposite the first surface, the second surface including a curved portion that curves toward the first surface.

20. The clamping assembly of claim 14, wherein:
the upper clamp portion includes:
a first surface configured to engage with the at least one fastening device, and
a second surface opposite the first surface, the second surface including a curved portion that curves toward the first surface.
